(19) United States
(12) Patent Application Publication
(10) Pub. No.: US 2009/0034599 A1
(43) Pub. Date: Feb. 5, 2009

(54) Method and apparatus for indicating the performance of a digital signal, based on a mapping of symbols extracted from the digital signal to one or more target symbol states

(76) Inventor: Roger L. Jungerman, Petaluma, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/888,732

(22) Filed: Aug. 1, 2007

(51) Int. Cl. H04B 3/46

(52) U.S. Cl. 375/228

(57) ABSTRACT

In one embodiment, a digital signal having a modulation format is demodulated, in real time, to extract symbols from the digital signal. The extracted symbols are then mapped to one or more target symbol states of the modulation format, in real time; and the performance of the digital signal is indicated based on the mapping of extracted symbols to the one or more target symbol states. Other embodiments are also disclosed.

### BACKGROUND

In analyzing the performance of a wireless digital system, one common metric is Bit Error Ratio (BER). Various system issues can lead to noise and disruption in the signal transmission giving rise to digital errors (incorrect bits in the transmission). However system impairments such as fading due to rain or other atmospheric effects can be gradual in many cases. If the impairment is not sufficient to cause bit errors, then it is not observed in a bit error ratio test. In the case of Gaussian errors (Gaussian statistics apply to many, but not all, noise phenomena), by measuring the digital system for a long time and looking for very rare bit errors, some insight into small impairments can be gained. In addition the evaluation of BER is complex, requiring demodulation, symbol recovery, comparison of the symbols against a known pattern sequence, and error counting. In many cases the digital pattern being sent is not a known test pattern and it is not possible to extract the BER. Also, modern wireless systems modulate with a wide range of modulation formats, such as Quadrature Amplitude Modulation (QAM), Quadrature Phase Shift Keying (QPSK), or Orthogonal Frequency Division Multiplexing (OFDM). There are also different digital packet and bit encoding formats providing error correction. For a BER measurement to be performed, the details of all of these parameters, as well as the test pattern being transmitted, must be known. This makes it difficult to design a general purpose test system that can be used to characterize a wide variety of modulation formats.

In the case of bursty noise phenomena, the statistics are typically not Gaussian. Thus, extrapolations from long measurements are often not accurate. The crux of the issue is that the impairments can actually change with time due to natural system changes (e.g. a rain storm). It is desirable to be able to evaluate the system margin even when errors are not occurring. This implies a parametric measurement that details the quality of each bit, not just that it is correct. The need for parametric measurements of wireless digital systems has lead to system metrics such as Error Vector Magnitude (EVM) that are often characterized in the in-phase/quadrature modulation (I/Q) plane. The location of each symbol in a digital transmission is compared to its ideal position in a constellation of I/Q coordinates. The magnitude of the distance between the two is called the EVM. A high performance digital system will have very low EVM (less than 1%, in some cases).

Typically, EVM measurements have been performed by using high dynamic range digitizers after down-converting a radio frequency (RF) signal to an intermediate frequency (IF) signal within the bandwidth of the digitizer. Thus, only a small memory record of the digitized signal is captured, and only a small fraction of the symbols in the RF signal are analyzed, and important (or rare) symbol events can be lost.

### BRIEF DESCRIPTION OF THE DRAWINGS

Illustrative embodiments of the invention are illustrated in the drawings, in which:

FIG. 1 illustrates an exemplary computer-implemented method for indicating the performance of a digital signal, based on a mapping of symbols extracted from the digital signal to one or more target symbol states;

FIGS. 2 & 3 illustrate exemplary constellations of I/Q coordinates that may be displayed by the method shown in FIG. 1;

FIG. 4 illustrates an exemplary error interval histogram; and

FIG. 5 illustrates an exemplary memory storing snapshots of activity occurring before and after error occurrences.

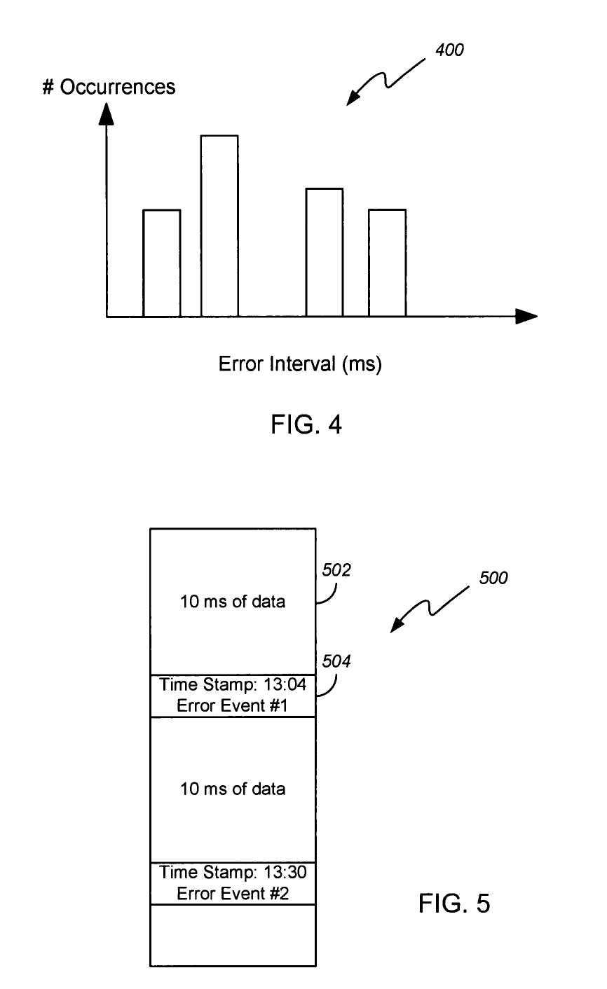

### DETAILED DESCRIPTION

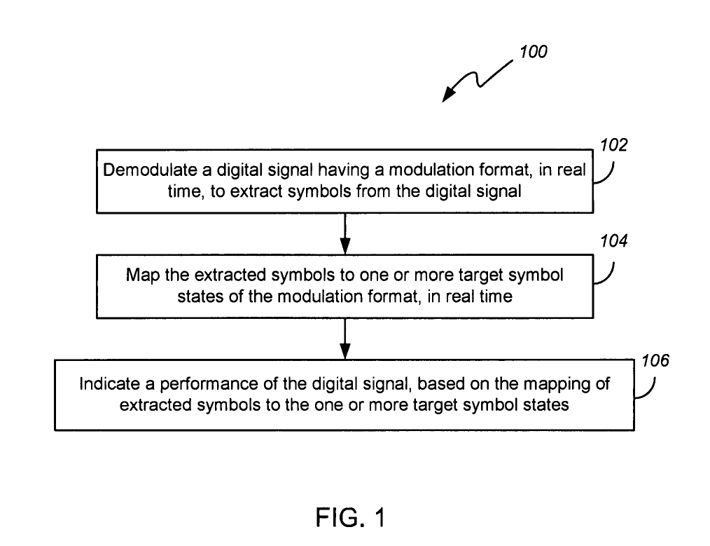

FIG. 1 illustrates a new and exemplary computer-implemented method 100. The method 100 comprises demodulating a digital signal having a modulation format, in real time, to extract symbols (e.g., bits) from the digital signal (at block 102). The extracted symbols are then mapped to one or more target symbol states of the modulation format in real time (at block 104), and a performance of the digital signal is indicated based on the mapping of extracted symbols to the one or more target symbol states (at block 106). In some embodiments, the digital signal's performance may also be indicated in real time (although it need not be).

In some case, the digital signal that is operated on by the method 100 may be an RF signal, and the RF signal may be demodulated by down-converting and digitizing the RF signal into a plurality of digital samples. The number of samples in the plurality of digital samples is preferably large, with the digital signal being sampled at more than twice the modulation bandwidth of the modulation format used (e.g., to avoid violating Nyquist sampling requirements). In the case of digital demodulation, the digital samples may be re-sampled to the symbol clock, by recovering the symbol clock from the digital signal, and then using the symbol clock to obtain a stable set of extracted symbols in the I/Q plane.

In addition to containing information on symbols themselves, digital samples may contain information relating to interfering signals, cross talk and other impairments. It is therefore useful to analyze the digital samples in detail to understand parametric system limitations. However, due to the very large quantity of digital samples that can be generated during demodulation, it is difficult to analyze all of the digital samples in detail. It can therefore be useful to implement a real time triggering mechanism, to enable the capture of selected segments of the digital signal for detailed post-analysis (as will be described in more detail later in this description). Depending on the scope of this post-analysis, it may not be possible to perform this analysis in real time.

The modulation format of the digital signal on which the method 100 operates may take various forms. For example, wireless modulation formats include, but are not limited to, QAM, QPSK and OFDM. Modulation formats such as these encode data within different modulation symbols, and encode and frame the symbols in many different ways.

Target symbol states are the states in a set of possible modulation states that are defined to represent some number of bits. In some cases, the parameters that define target symbol states can be the complex I and Q coordinates of a desired modulation format. For example, the QPSK modulation format comprises four “modulation” or “target symbol” states (arranged in a square in the I/Q plane). Each QPSK target symbol state (4 possibilities) represents 2 binary bits of information content. QPSK symbols that are extracted from a digital signal (i.e., extracted symbols) will typically have I/Q coordinates that are near one of the four QPSK target symbol states (unless there is a severe degradation in the digital signal's performance). One way to represent the error between an extracted symbol (or extracted symbol state) and a target symbol state is via error vector magnitude (EVM). The EVM for an extracted symbol represents the distance between the I/Q coordinates of the extracted symbol and the I/Q coordinates of a target symbol state. The purpose of EVM (and EVMER, discussed later in this description) is to determine how many symbols are mapped to ambiguous positions which would result in improperly mapping an extracted symbol to an incorrect target symbol state.

In the case of digital demodulation, mentioned above, where digital samples are re-sampled to the symbol clock, and where the symbol clock is used to obtain a stable set of extracted symbols in the I/Q plane, the mapping of extracted symbols to target symbol states preferably comprises mapping extracted symbols that are within predetermined ranges of target symbol states to respective target symbol states (based on, for example, the I/Q coordinates of extracted symbols and target symbol states being within a predetermined EVM). Extracted symbols that fall outside of the predetermined ranges may remain unmapped. Or, in some embodiments, every extracted symbol may be mapped to a “closest” target symbol state. If an extracted symbol falls between two equally close target symbol states, the extracted symbol may in some cases be mapped to a default target symbol state.

The method 100 is useful, in one respect, in that it can be used to indicate the performance of digital signals associated with a wide range of modulation formats and data encoding approaches. While some modulation formats can be represented using an I/Q plot, others, like OFDM, are more complicated. In OFDM, each subcarrier is modulated with an independent I/Q modulation. OFDM modulation typically requires a fast Fourier transform (FFT) to separate the subcarriers. While the computational hardware for demodulation of more complex formats, such as OFDM, is more challenging the real time display and triggering approaches are not limited to a simple I/Q plane modulation.

The mapping of extracted symbols to target symbol states may in some cases result in erroneous mappings. If erroneous mappings are made, bit errors will result.

As previously noted, at least the demodulating and mapping steps of the method 100 are performed in real time. By “real time”, it is meant that method steps are begun as or while a digital signal is being received, or that steps are performed on a continuous stream of digitized samples. “Real time” performance of method steps is contrasted with batch completion of steps, wherein a plurality of digitized samples is captured, stored in memory, and then post-analyzed (typically in software). The real time completion of at least demodulation and mapping can be advantageous in that real time (and often transient) events can be captured for either display or real time trigger generation. In the latter case, a real time event can be used, for example, to trigger the preservation of buffered or newly received samples in memory. In a batch capture method, events are likely to be unusable as triggers, as they are not discovered until related events have already passed. Another problem with a batch capture method is that storing a batch of extracted symbols can consume significant memory or storage resources. As a result, it is common to store only a small fraction of extracted symbols in a batch (such as every Nth symbol), and the likelihood of missing transient events because an affected symbol was not stored is high. Real time can generate better EVMER statistics, because all of the symbols extracted from a digital signal can be analyzed.

The method 100 may indicate the performance of a digital signal using various types of performance indicators, including parametric and non-parametric performance indicators. A non-parametric performance indicator merely indicates whether the symbols or bits of a digital signal are correct, while a parametric performance indicator indicates, for example, whether there is degradation in the performance of a digital signal. For example, a digital signal may be introduced to significant noise via its analog or wireless signal path, without the noise leading to any observable error. However, incremental analog performance degradation can eventually result in total digital system failure. It is therefore desirable to parametrically quantify the system margin, so system reliability can be improved, maintained and ensured.

One performance indicator is BER, which is indicative of the number of demodulated bits that are received in error. BER requires the sending of a test pattern (or other known pattern) to be sent through a system, so that the deviation between the test pattern and a received pattern can be observed. Error vector magnitude error ratio (EVMER) is another performance indicator, which indicates what fraction of received (i.e., extracted) symbols are within a predetermined range of a target symbol state. Graphical displays of extracted symbol and target symbol state locations, such as I/Q plots, also give a qualitative display of digital signal performance. Alerts that indicate when an extracted symbol is found to be sufficiently distant from a target symbol state can also be indicators of a digital signal's performance (with the frequency of alerts being indicative of how poorly a signal is performing). In addition the trigger event can be used to capture the full digital data stream (or a set of processed symbol states) for post-analysis to determine more precisely the cause of the triggering event indicating poor performance.

The method 100 may be implemented, at least in part, by means of digital hardware, such as a digital signal processor (DSP) that includes a field-programmable gate array (FPGA) or application-specific integrated circuit (ASIC). Implementing part or all of the method 100 via a DSP enables real time operation of the method 100 at higher symbol rates. The use of a DSP having a local oscillator also helps when operating the method 100 at higher symbol rates, because a local oscillator enables faster locking to the symbol clock (i.e., the transmission clock). Parts of the method 100 may also be implemented via computer-readable code stored on computer-readable media. The computer-readable media may include, for example, any number or mixture of fixed or removable media (such as one or more fixed disks, random access memories (RAMs), read-only memories (ROMs), or compact discs), at either a single location or distributed over a network. The computer-readable code is executable by a computer, to cause the computer to perform the method 100. In one embodiment, the method 100 is performed by a DSP that generates an output indicative of digital signal performance. A graphical user interface (GUI)—the content of which is at least partly generated by means of a computer executing computer-readable code—then generates a display based on the output of the DSP.

In some embodiments of the method 100, the method 100 may comprise determining an acceptable range of I/Q coordinates for each of the one or more target symbol states of a digital signal's modulation format. The performance of the digital signal may then be indicated by 1) determining a constellation of I/Q coordinates for the symbols that are extracted from the digital signal, 2) displaying the constellation of I/Q coordinates in an I/Q plane, and 3) indicating whether I/Q coordinates in the displayed constellation are outside of the acceptable ranges of I/Q coordinates for the target symbol state(s). In one embodiment, the constellation of I/Q coordinates is determined and displayed in real time, as symbols are being extracted from a digital signal.

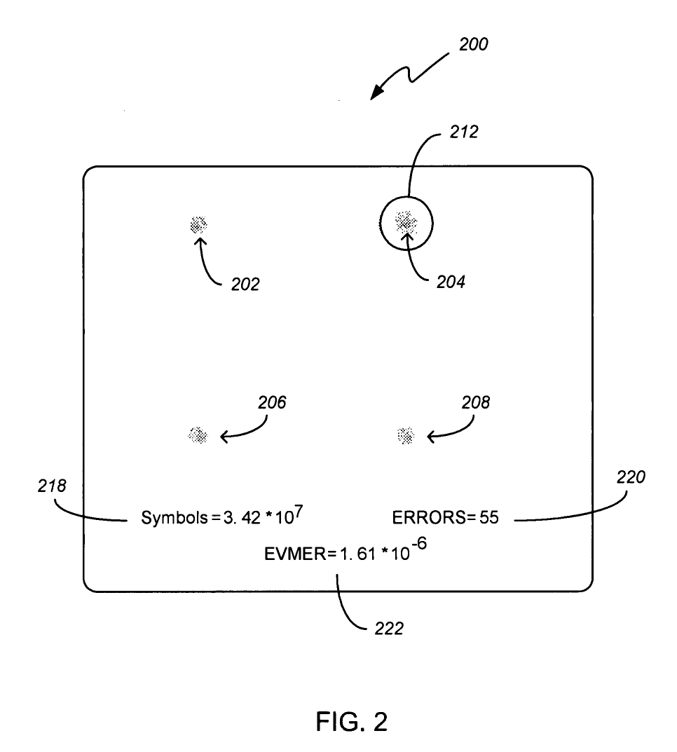

FIG. 2 illustrates an exemplary constellation of I/Q coordinates 202, 204, 206, 208 that may be displayed by the method 100. In some embodiments of the method 100, the constellation may be displayed within a window 200 of a graphical user interface (GUI).

As shown in FIG. 2, an acceptable range of I/Q coordinates 204 may be indicated by means of a circular boundary line 212 that defines the acceptable range. In FIG. 2, only one boundary line 212, defining an acceptable range of I/Q coordinates 204 for one target symbol state, is shown. However, in the window 300 shown in FIG. 3, boundary lines 210, 212, 214, 216 defining acceptable ranges of I/Q coordinates 202, 204, 206, 208 for four target symbol states are shown.

The acceptable range of I/Q coordinates for a particular target symbol state, and thus the boundary line 212 for an acceptable range of I/Q coordinates 204, may be determined in a variety of ways. In one embodiment, an acceptable range is based on 1) I/Q coordinates of a particular target symbol state, and 2) a radius centered on the I/Q coordinates of the particular target symbol state. In one embodiment, the I/Q coordinates of the target symbol state, and the radius, may be obtained from a look-up table. Alternately, the radius may be provided by a user.

In one embodiment, the performance of a digital signal may be indicated by displaying, for a particular target symbol state, a plot of 1) varying radius coordinates that define ranges of I/Q coordinates about a set of I/Q coordinates for a target symbol state, versus 2) corresponding counts of extracted symbols having I/Q coordinates that fall outside of the ranges of I/Q coordinates. In this manner, a user may not only discern the performance of a digital signal, but the user may choose a radius that provides a desired error tolerance, and thereby define an acceptable range of I/Q coordinates for a target symbol state. A plot of radius coordinates versus counts of extracted symbols having I/Q coordinates that fall outside ranges defined by the radius coordinates can also be used to validate bit error ratio (BER) estimations, or can be related to true BER measurements (assuming a Gaussian noise distribution). See, Fitz et al., “Transmitter Performance Characterization with Amplitude and Phase EVM”, Radio and Wireless Symposium, 2007 IEEE (Jan. 9-11, 2007).

In one embodiment, a constellation of I/Q coordinates is displayed in a color-grade display, where each set of I/Q coordinates in the constellation is coded in a color that indicates a running count of extracted symbols that share the set of I/Q coordinates. Thus, for example, I/Q coordinates having lots of “hits” might be displayed in green, often indicating a high likelihood that the coordinates are acceptable coordinates. Coordinates that have few hits might then be displayed in red. Or, a set of coordinates could cycle through a progression of three or more colors (or a range of contiguous colors) as the coordinates are associated with more and more extracted symbol hits.

As symbols are extracted from a digital signal, various counts of extracted symbols and errors may be maintained and displayed. For example, in one embodiment, a running count of extracted symbols 218, and a running count of extracted symbols having I/Q coordinates that fall outside all of the acceptable ranges 220, may be maintained (and displayed to a user). See, FIG. 2. From these counts, an Error Vector Magnitude error rate (EVMER) 222 may be calculated and displayed. While not a true BER measurement, the EVMER gives an indication of the system quality for a wide range of modulation formats and data encoding and does not require a known data test pattern sequence.

In another embodiment, a running count of extracted symbols having I/Q coordinates that fall within an error range for a particular target symbol state, outside of the acceptable range of I/Q coordinates for the particular target symbol state, may be maintained (and displayed to a user). Although not shown in the figures, this embodiment would appear similar to the embodiment shown in FIG. 2, but with a modification of the counts and EVMER to only reflect data for one particular target symbol state (such as the symbol corresponding to the encircled area 212).

In yet another embodiment, and for each acceptable range of I/Q coordinates 202, 204, 206, 208, running counts of extracted symbols, and counts of extracted symbols having I/Q coordinates that fall within error ranges outside of each acceptable range, may be maintained. The counts corresponding to the various acceptable ranges (i.e., counts corresponding to different symbols) may be simultaneously displayed. Per symbol EVMERs may also be calculated and displayed. See, FIG. 3. The counts may also be color coded, or otherwise highlighted or accentuated, to indicate which ones of the counts or EVMERs, if any, exceed thresholds.

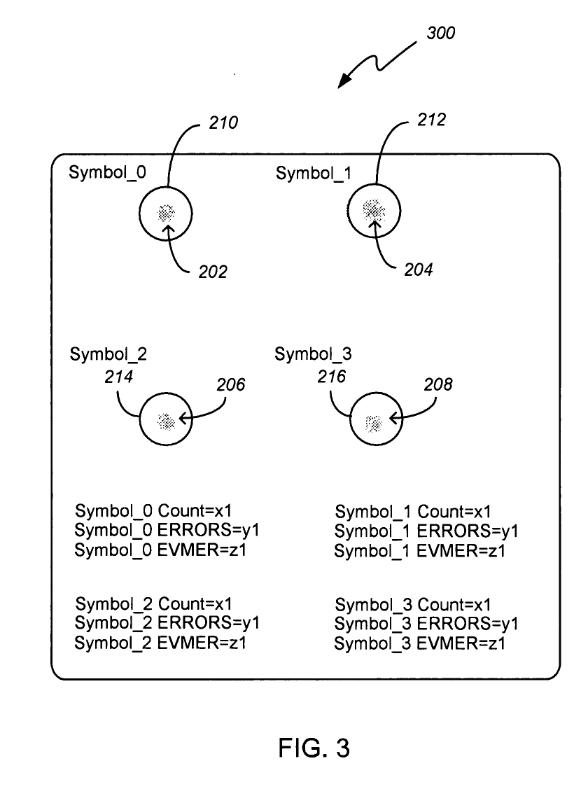

In addition to displaying a constellation diagram, the method 100 may display an error interval histogram 400. See, FIG. 4. This may be done by counting the number of symbols that are extracted from a digital signal between symbols having I/Q coordinates that fall outside of an acceptable range of I/Q coordinates. An error interval histogram 400, such as the one shown in FIG. 4, may then be displayed based on the counted numbers of symbols between errors. In the histogram 400, the horizontal access is labeled “Error Interval” (in milliseconds (ms)), and the vertical access is labeled “# Occurrences”. An error interval histogram 400 can be useful, in one respect, in designing block coding forward error correction (FEC) algorithms to correct errors in signal transmission.

In yet another embodiment of the method 100, data pertaining to the digital signal may be stored in a circular buffer. The data may comprise, for example, an unprocessed segment of the digital signal, raw digitized samples, or I/Q coordinates for up to a predetermined plurality of extracted symbols. A circular buffer is a buffer in which data is stored in an ordered fashion, until the buffer is full. As additional data is presented to the buffer, existing data is replaced in the same ordered fashion. Using a circular buffer, data pertaining to a digital signal may be temporarily stored. By way of example, a circular buffer may be implemented as a stand-alone structure, or as a portion of a shared memory.

At or about the same time that data pertaining to a digital signal is being stored in the circular buffer, a real time determination may be made as to 1) whether I/Q coordinates for a particular extracted symbol are outside of acceptable range(s), or 2) whether other parameters of a digital signal or its symbols are out of range. If so, at least a portion of the data stored in the circular buffer may be preserved in memory (e.g., copied from the circular buffer to memory; or in cases where the circular buffer is implemented in memory, merely saved). In this manner, memory is better managed, by not saving data pertaining to all extracted symbols, but instead only saving a snapshot of activity before or after an error occurrence. Furthermore, signal performance before and after a trigger event (such as an EVM or EVMER trigger) can be analyzed in detail at a later time—making it possible to isolate or cull through a vast amount of digital data in real time, and then isolate and save only that data which is pertinent to events that require more detailed analysis.

In one embodiment, a block 502 of data stored in memory 500 may be associated with one or more time stamps 504 indicating the timing(s) of error(s) that are associated with the block 502.

What is claimed is:

1. A method, comprising:
demodulating a digital signal having a modulation format, in real time, to extract symbols from the digital signal;
mapping the extracted symbols to one or more target symbol states of the modulation format, in real time; and
indicating a performance of the digital signal, based on the mapping of extracted symbols to the one or more target symbol states.

2. The method of claim 1, further comprising:
calculating an error vector magnitude error ratio (EVMER) for at least some of the extracted symbols, in real time;
wherein indicating the performance of the digital signal includes displaying a performance indicator based on the EVMER.

3. The method of claim 1, further comprising:
determining an acceptable range of I/Q coordinates for each of the one or more target symbol states;
wherein indicating the performance of the digital signal includes,
determining a constellation of I/Q coordinates for the extracted symbols;
displaying the constellation of I/Q coordinates in an I/Q plane; and
indicating whether I/Q coordinates in the displayed constellation are outside of the acceptable range(s) of I/Q coordinates for the target symbol state(s).

4. The method of claim 3, wherein the acceptable range of I/Q coordinates for a particular target symbol state is based on 1) I/Q coordinates of the particular target symbol state, and 2) a radius centered on the I/Q coordinates of the particular target symbol state.

5. The method of claim 3, wherein indicating whether I/Q coordinates in the displayed constellation are outside of the acceptable range(s) of I/Q coordinates comprises displaying at least one circular boundary line to define at least one of the acceptable ranges.

6. The method of claim 1, further comprising:
determining an acceptable range of I/Q coordinates for a particular target symbol state; and
determining I/Q coordinates for the extracted symbols, in real time;
wherein indicating the performance of the digital signal includes displaying a running count of extracted symbols having I/Q coordinates that fall within an error range for the particular target symbol state, which error range is outside of the acceptable range of I/Q coordinates for the particular target symbol state.

7. The method of claim 1, further comprising:
determining an acceptable range of I/Q coordinates for each of the one or more target symbol states; and
determining I/Q coordinates for the extracted symbols, in real time;
wherein indicating the performance of the digital signal includes,
simultaneously displaying, for each acceptable range of I/Q coordinates, running counts of extracted symbols having I/Q coordinates that fall within error ranges outside each acceptable range; and
color coding the counts to indicate whether any of the counts exceed a threshold.

8. The method of claim 1, further comprising:
determining an acceptable range of I/Q coordinates for each of the one or more target symbol states; and
determining I/Q coordinates for the extracted symbols, in real time;
wherein indicating the performance of the digital signal includes displaying i) a running count of extracted symbols, and ii) a running count of extracted symbols having I/Q coordinates that fall outside all of the acceptable ranges.

9. The method of claim 1, wherein indicating the performance of the digital signal includes,
determining a constellation of I/Q coordinates for the extracted symbols;
displaying the constellation in an IQ plane; and
displaying the constellation in a color-grade display, where each set of I/Q coordinates in the constellation is coded in a color that indicates a running count of extracted symbols that share the set of I/Q coordinates.

10. The method of claim 1, further comprising:
determining I/Q coordinates for the extracted symbols, in real time;
wherein indicating the performance of the digital signal includes, displaying, for a particular one of the target symbol states, a plot of 1) varying radius coordinates defining acceptable ranges of I/Q coordinates about the I/Q coordinates of the particular target symbol state, versus 2) corresponding counts of extracted symbols having I/Q coordinates that fall outside of the acceptable ranges of I/Q coordinates.

11. The method of claim 1, further comprising:
determining an acceptable range of I/Q coordinates for at least one of the target symbol states;
determining I/Q coordinates for the extracted symbols, in real time; and
when the I/Q coordinates of an extracted symbol fall outside of the acceptable range of I/Q coordinates for the particular target symbol state to which the extracted symbol is mapped, counting a number of symbols that is extracted from the digital signal before the I/Q coordinates of another extracted symbol falls outside of an acceptable range of I/Q coordinates;
wherein indicating the performance of the digital signal includes displaying an error interval histogram based on the counted numbers of symbols.

12. The method of claim 1, further comprising:
determining an acceptable range of I/Q coordinates for each of the one or more target symbol states;
determining I/Q coordinates for the extracted symbols, in real time;
storing, in a circular buffer, data pertaining to the digital signal;
determining, in real time, whether I/Q coordinates for extracted symbols are outside of the acceptable range(s); and
upon determining that I/Q coordinates for a particular extracted symbol are outside of the acceptable range(s), preserving in memory at least a portion of the data stored in the circular buffer.

13. The method of claim 1, further comprising, indicating the performance of the digital signal in real time.

14. Apparatus, comprising:
a digital signal processor (DSP) configured to,
demodulate a digital signal having a modulation format, in real time, to extract symbols from the digital signal;
map the extracted symbols to one or more target symbol states of the modulation format, in real time; and
output, based on the mapping of extracted symbols to the one or more target symbol states, an indication of performance of the digital signal.

15. The apparatus of claim 14, wherein:
the DSP is further configured to calculate an error vector magnitude error ratio (EVMER) for at least some of the extracted symbols, in real time; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface to indicate the performance of the digital signal by displaying a performance indicator based on the EVMER.

16. The apparatus of claim 14, wherein:
the DSP is further configured to i) determine an acceptable range of I/Q coordinates for each of the one or more target symbol states, and ii) determine a constellation of I/Q coordinates for the extracted symbols; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface (GUI) to indicate the performance of the digital signal by i) displaying the constellation of I/Q coordinates in an I/Q plane, and ii) indicating whether I/Q coordinates in the displayed constellation are outside of the acceptable range(s) of I/Q coordinates for the target symbol state(s).

17. The apparatus of claim 16, wherein the acceptable range of I/Q coordinates for a particular target symbol state is based on 1) I/Q coordinates of the particular target symbol state, and 2) a radius centered on the I/Q coordinates of the particular target symbol state.

18. The apparatus of claim 16, wherein the computer-readable code causes the GUI to indicate whether I/Q coordinates in the displayed constellation are outside of the acceptable range(s) of I/Q coordinates by causing the GUI to display at least one circular boundary line to define at least one of the acceptable ranges.

19. The apparatus of claim 14, wherein:
the DSP is further configured to i) determine an acceptable range of I/Q coordinates for a particular target symbol state, and ii) determine I/Q coordinates for the extracted symbols, in real time; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface (GUI) to indicate the performance of the digital signal by displaying a running count of extracted symbols having I/Q coordinates that fall within an error range for the particular target symbol state, which error range is outside of the acceptable range of I/Q coordinates for the particular target symbol state.

20. The apparatus of claim 14, wherein:
the DSP is further configured to i) determine an acceptable range of I/Q coordinates for each of the one or more target symbol states, and ii) determine I/Q coordinates for the extracted symbols, in real time; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface (GUI) to indicate the performance of the digital signal by i) simultaneously displaying, for each acceptable range of I/Q coordinates, running counts of extracted symbols having I/Q coordinates that fall within error ranges outside each acceptable range, and ii) color coding the counts to indicate whether any of the counts exceed a threshold.

21. The apparatus of claim 14, wherein:
the DSP is further configured to i) determine an acceptable range of I/Q coordinates for each of the one or more target symbol states, and ii) determine I/Q coordinates for the extracted symbols, in real time; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface (GUI) to indicate the performance of the digital signal by i) displaying a running count of extracted symbols, and ii) displaying a running count of extracted symbols having I/Q coordinates that fall outside all of the acceptable ranges.

22. The apparatus of claim 14, wherein:
the DSP is further configured to determine a constellation of I/Q coordinates for the extracted symbols; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface (GUI) to indicate the performance of the digital signal by i) displaying the constellation in an I/Q plane, and ii) displaying the constellation in a color-grade display, where each set of I/Q coordinates in the constellation is coded in a color that indicates a running count of extracted symbols that share the set of I/Q coordinates.

23. The apparatus of claim 14, wherein:
the DSP is further configured to determine I/Q coordinates for the extracted symbols, in real time; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface (GUI) to indicate the performance of the digital signal by displaying, for a particular one of the target symbol states, a plot of 1) varying radius coordinates defining acceptable ranges of I/Q coordinates about the I/Q coordinates of the particular target symbol state, versus 2) corresponding counts of extracted symbols having I/Q coordinates that fall outside of the acceptable ranges of I/Q coordinates.

24. The apparatus of claim 14, wherein:
the DSP is further configured to i) determine an acceptable range of I/Q coordinates for at least one of the target symbol states, ii) determine I/Q coordinates for the extracted symbols, in real time, and iii) when the I/Q coordinates of an extracted symbol fall outside of the acceptable range of I/Q coordinates for the particular target symbol state to which the extracted symbol is mapped, count a number of symbols that is extracted from the digital signal before the I/Q coordinates of another extracted symbol falls outside of an acceptable range of I/Q coordinates; and
the apparatus further comprises computer-readable media, and computer-readable code that is stored on the computer-readable media, wherein the computer-readable code is executable by a computer, and wherein the computer-readable code includes code that, in response to the output of the DSP, causes a graphical user interface (GUI) to indicate the performance of the digital signal by displaying an error interval histogram based on the counted numbers of symbols.

25. The apparatus of claim 14, wherein the DSP is further configured to:
determine an acceptable range of I/Q coordinates for each of the one or more target symbol states;
determine I/Q coordinates for the extracted symbols, in real time;
cause data pertaining to the digital signal to be stored in a circular buffer;
determine, in real time, whether I/Q coordinates for extracted symbols are outside of the acceptable range(s); and
upon determining that I/Q coordinates for a particular extracted symbol are outside of the acceptable range(s), cause the computer to preserve in memory at least a portion of the data stored in the circular buffer.

26. The apparatus of claim 14, wherein the output indicates the performance of the digital signal in real time.
